(19) United States
(12) Patent Application Publication
(10) Pub. No.: US 2021/0221070 A1
(43) Pub. Date: Jul. 22, 2021

(54) INFRARED WELDING DEVICE

(71) Applicant: TOYOTA JIDOSHA KABUSHIKI KAISHA, Toyota-shi (JP)

(72) Inventor: Youichiro BABA, Miyoshi-shi (JP)

(73) Assignee: TOYOTA JIDOSHA KABUSHIKI KAISHA, Toyota-shi (JP)

(21) Appl. No.: 17/078,516

(22) Filed: Oct. 23, 2020

(30) Foreign Application Priority Data
Jan. 17, 2020 (JP) 2020-005733

(51) Int. Cl. B29C 65/14; B29C 65/00

(52) U.S. Cl. CPC B29C 65/1412; B29C 66/0242

(57) ABSTRACT

An infrared welding device successively joins component members of a liner to one another. The infrared welding device is equipped with collet chucks that hold domes and a pipe slidably and coaxially with gaps created therebetween respectively, infrared radiation lamps that melt end portions of the domes and end portions of the pipe through heating respectively, vertical operation mechanisms that move the infrared radiation lamps between insertion positions and retreat positions respectively, and a pressing mechanism and a pressure-receiving mechanism that press the end portions of the domes against the end portions of the pipe respectively.

### CROSS-REFERENCE TO RELATED APPLICATION

This application claims priority to Japanese Patent Application No. 2020-005733 filed on Jan. 17, 2020, incorporated herein by reference in its entirety.

### BACKGROUND

### 1. Technical Field

The disclosure relates to an infrared welding device that simultaneously or successively joins a plurality of members constituting a liner of a tank to one another through welding.

### 2. Description of Related Art

From the standpoint of weight reduction, it is common to use a high-pressure tank having an inner shell as a resinous liner, and a high-strength outer shell formed by winding carbon fiber around an outer peripheral surface of the liner, as a hydrogen tank mounted in a fuel cell-powered vehicle.

This liner is usually formed in the shape of a sealed cylinder with both ends thereof substantially closed, so at least one joint portion is created. For example, when bottomed cylinder-shaped domes are joined to each other in an axial direction, a single joint portion is created. Besides, for example, two domes and a cylindrical pipe are joined to one another in the axial direction with the pipe sandwiched between the domes, two joint portions are created.

Thus, in the case where two domes and a pipe are component members constituting a liner (which will be referred to hereinafter also as “liner component members”), it is common to form two joint portions in two separate stages, for example, by press-bonding an end portion of one of the domes and one end portion of the pipe to each other in a molten state and then press-bonding an end portion of the other dome and the other end portion of the pipe to each other in a molten state. The two joint portions are thus formed in two separate stages, because there is an apprehension as to whether or not good joint portions are obtained when welding is simultaneously carried out at two positions.

However, according to the method in which the two joint portions are formed in two separate stages, there is a problem in that the time for manufacturing the liner is difficult to reduce.

Thus, for example, Japanese Unexamined Patent Application Publication No. 2006-283968 (JP 2006-283968 A) discloses an art of simultaneously forming two joint portions by butting end portions of two domes and end portions of a pipe against each other respectively and then simultaneously irradiating butted regions with laser light from two laser torches respectively during or after preheating.

### SUMMARY

However, laser light is small in diameter and low in heating efficiency. Therefore, according to the foregoing art of JP 2006-283968 A in which laser light is used, joining requires a time that is about ten times as long as in the case of a conventional infrared welding method. Although the trouble is taken to simultaneously form the two joint portions, there is a problem in that the manufacturing time is prolonged as the opposite effect.

The disclosure has been made in view of the foregoing circumstances. It is an object of the disclosure to provide an art of reducing the manufacturing time in an infrared welding device that joins three or more liner component members to one another through welding, while forming good joint portions.

In order to solve the aforementioned problem, as a result of earnest investigations, the inventor obtained the knowledge that even when two or more joint portions are substantially simultaneously formed, the good joint portions are obtained with one of the joint portions not adversely affecting the other joint portion, as long as three or more liner component members are firmly pressed against one another while being held coaxially with one another.

Thus, with an infrared welding device according to the disclosure based on this knowledge, after end portions of three or more liner component members are simultaneously melted through heating, the liner component members are then relatively moved while being held coaxially with one another, and are swiftly joined to one another.

In concrete terms, the disclosure relates to an infrared welding device that simultaneously or successively joins three component members constituting a liner of a tank to one another through welding.

Moreover, this infrared welding device is equipped with a member holding unit that holds a dome, a pipe, and another dome as the component members in this sequence, coaxially with one another and apart from one another, a heating unit that is inserted between each of the domes and the pipe and that melts an end portion of each of the domes and an end portion of the pipe though heating by infrared light, a moving unit that moves the heating unit between an insertion position where the heating unit is inserted between each of the domes and the pipe, and a retreat position where the heating unit is retreated from between each of the domes and the pipe, and a pressing unit that relatively moves each of the domes toward the pipe and that presses the end portion of each of the domes against the end portion of the pipe. The member holding unit holds at least each of the domes slidably in an axial direction. The moving unit retreats the heating unit to the retreat position, and the pressing unit presses the end portion of each of the domes against the end portion of the pipe, after the heating unit arranged at the insertion position melts the end portion of each of the domes and the end portion of the pipe through heating.

According to this configuration, a state where the domes and the pipe can be joined to one another can be swiftly created by retreating the heating unit to the retreat position by the moving unit, after melting the end portion of each of the domes and the end portion of the pipe through heating by infrared light through the use of the heating unit.

Then, the member holding unit that holds the liner component members coaxially with one another holds at least each of the domes slidably in the axial direction. Thus, the two domes and the pipe can be simultaneously or successively joined to one another by relatively moving each of the domes toward the pipe by the pressing unit. Thus, the manufacturing time can be reduced. For example, in the case where the pipe is also slidable in the axial direction, when the end portion of one of the domes is pressed against one end portion of the pipe, the pipe moves together with that one of the domes in the pressing direction, and the other end portion of the pipe that has moved is pressed against the end portion of the other dome. Thus, the two domes and the pipe can be successively joined to one another. Besides, for example, in the case where the pipe is fixed, the two domes and the pipe can be simultaneously joined to one another, by simultaneously pressing the end portions of both the domes against both the end portions of the pipe respectively.

Besides, while being held coaxially with one another, the two domes and the pipe are firmly press-bonded to one another due to a pressing force by the pressing unit, a reactive force corresponding thereto, and the like. Therefore, the two good joint portions can be obtained, even when these joint portions are simultaneously or successively formed.

Moreover, as a concrete example of the configuration of the device, in the foregoing infrared welding device, the member holding unit may hold each of the domes and the pipe slidably in the axial direction, and the pressing unit may have a pressing mechanism that presses one of the domes against the pipe, and a pressure-receiving mechanism that receives the other dome and that restrains the other dome from moving in a direction in which that one of the domes is pressed by the pressing mechanism.

According to this configuration, the member holding unit holds each of the domes and the pipe slidably in the axial direction. Thus, when the end portion of one of the domes is pressed against one end portion of the pipe by the pressing mechanism, the pipe moves in the pressing direction correspondingly, and the other end portion of the pipe that has moved is pressed against the end portion of the other dome. At this time, the other dome pushed by the pipe is received by the pressure-receiving mechanism. Therefore, the end portion of the other dome is also relatively pressed against the other end portion of the pipe, due to the reactive force of the pressure-receiving mechanism. Accordingly, the two domes and the pipe can be firmly press-bonded to one another. Thus, the good joint portions can be obtained.

Besides, as another concrete example of the configuration of the device, in the foregoing infrared welding device, the member holding unit may hold each of the domes and the pipe slidably in the axial direction, and the pressing unit may have a first pressing mechanism that presses one of the domes against the pipe, and a second pressing mechanism that presses the other dome in a direction opposite a direction in which that one of the domes is pressed by the first pressing mechanism, substantially simultaneously with the pressing by the first pressing mechanism.

According to this configuration, when the end portion of one of the domes is pressed against one end portion of the pipe by the first pressing mechanism, the end portion of the other dome is substantially simultaneously pressed against the other end portion of the pipe by the second pressing mechanism. In this manner, by using the two pressing mechanisms, the stroke of each of the pressing mechanisms can be made about half as long as when the single pressing mechanism is used. Therefore, the manufacturing time can be further reduced.

Moreover, the member holding unit holds each of the domes and the pipe slidably in the axial direction. Thus, the two domes and the pipe can be firmly press-bonded to one another by the first and second pressing mechanisms that press the domes against the pipe respectively in opposite directions. Thus, the good joint portions can be obtained.

Furthermore, as still another concrete example of the configuration of the device, in the foregoing infrared welding device, the member holding unit may hold each of the domes slidably in the axial direction, and hold the pipe immovably in the axial direction, and the pressing unit may have a first pressing mechanism that presses one of the domes against the pipe, and a second pressing mechanism that presses the other dome in a direction opposite a direction in which that one of the domes is pressed by the first pressing mechanism, substantially simultaneously with the pressing by the first pressing mechanism.

According to this configuration, by using the two pressing mechanisms, the stroke of each of the pressing mechanisms can be made about half as long as when the single pressing mechanism is used. Therefore, the manufacturing time can be further reduced.

Moreover, the member holding unit holds the pipe immovably in the axial direction while holding each of the domes slidably in the axial direction. Therefore, even when there is a slight difference between the pressing force of the first pressing mechanism and the pressing force of the second pressing mechanism, the two domes and the pipe can be firmly press-bonded to one another, without changing the position of the central pipe. Thus, the good joint portions can be obtained.

Besides, the disclosure also relates to an infrared welding device that successively joins four component members constituting a liner of a tank to one another through welding.

Moreover, this infrared welding device is equipped with a member holding unit that holds a dome, two pipes, and another dome as the component members in this sequence coaxially with one another and apart from one another, a heating unit that is inserted between each two of the component members and that melts end portions of each two of the component members through heating by infrared light, a moving unit that moves the heating unit between an insertion position where the heating unit is inserted between each two of the component members, and a retreat position where the heating unit is retreated from between each two of the component members, and a pressing unit that relatively moves each of the domes toward each of the pipes and that presses the end portion of each of the component members against the end portion of the component member adjacent to that one of the component members. The moving unit retreats the heating unit to the retreat position, and the pressing unit presses the end portion of each of the component members against the end portion of the component member adjacent to that one of the component members, after the heating unit arranged at the insertion position melts the end portions of each two of the component members through heating.

According to this configuration, even in the case where there are four liner component members, the manufacturing time can be reduced while forming good joint portions, as in the case where there are three liner component members.

As described above, with the infrared welding device according to the disclosure, even when three or more liner component members are joined to one another through welding, the manufacturing time can be reduced while forming good joint portions.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view schematically showing a high-pressure tank that is equipped with a liner according to the first embodiment of the disclosure;

FIG. 2 is a cross-sectional view schematically showing line component members;

FIG. 3 is a view schematically showing an infrared welding device;

FIG. 4 is a perspective view schematically showing one of collet chucks;

FIG. 5 is a cross-sectional view schematically showing one of the collet chucks;

FIG. 6 is a plan view schematically showing one of infrared radiation lamps;

FIG. 7 is a front view schematically showing one of the infrared radiation lamps;

FIG. 8 is a view schematically illustrating a manufacturing process through the use of the infrared welding device;

FIG. 9 is another view schematically illustrating the manufacturing process through the use of the infrared welding device;

FIG. 10 is still another view schematically illustrating the manufacturing process through the use of the infrared welding device;

FIG. 11 is a view schematically showing an infrared welding device according to the second embodiment of the disclosure; and

FIG. 12 is a view schematically showing an infrared welding device according to the third embodiment of the disclosure.

### DETAILED DESCRIPTION OF EMBODIMENTS

Modes for carrying out the disclosure will be described hereinafter based on the drawings.

### First Embodiment

—Liner—

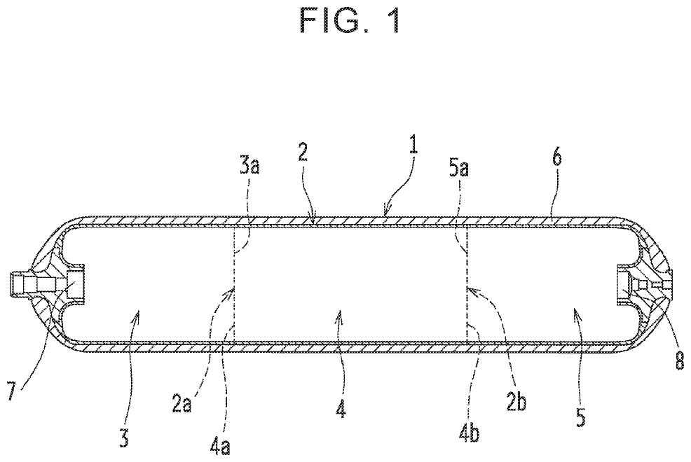

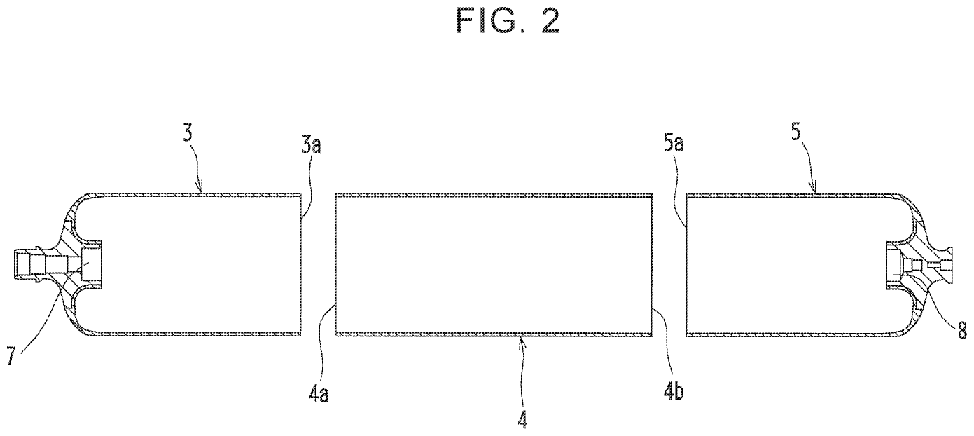

FIG. 1 is a cross-sectional view schematically showing a high-pressure tank 1 that is equipped with a liner 2 according to the present embodiment, and FIG. 2 is a cross-sectional view schematically showing liner component members 3, 4, and 5. The high-pressure tank 1 is mounted in a fuel cell-powered vehicle, and stores high-pressure hydrogen for electric power generation. As shown in FIG. 1, the high-pressure tank 1 is equipped with a substantially cylindrical liner 2 as an inner shell, a carbon fiber 6 that forms an outer shell by being wound around an outer periphery of the liner 2 and being stacked thereon, and aluminum ferrules 7 and 8 that are assembled with both ends of the liner 2 through press-fitting respectively.

The liner 2 is made of resin, and is constituted of the three substantially cylindrical liner component members 3, 4, and 5 separately formed through injection molding, as shown in FIG. 2. In concrete terms, the liner 2 is configured by sandwiching a single cylindrical pipe 4 between two bottomed cylinder-shaped domes 3 and 5 and joining the pipe 4 and the domes 3 and 5 to one another in an axial direction. The domes 3 and 4 and the pipe 4 are joined to one another through welding according to an infrared welding method in which an end portion 3a of the dome 3, end portions 4a and 4b of the pipe 4, and an end portion 5a of the dome 5 are melted through heating by infrared light and the domes 3 and 5 and the pipe 4 are pressure-bonded to one another.

Incidentally, for the sake of convenience of explanation, the left dome 3 in FIG. 2 will be referred to hereinafter also as the first dome 3, and the right dome 5 in FIG. 2 will be referred to hereinafter also as the second dome 5.

—Infrared Welding Device—

By the way, when the first dome 3, the pipe 4, and the second dome 5 are joined to one another in the axial direction with the pipe 4 sandwiched between the first dome 3 and the second dome 5, two joint portions 2a and 2b are created as shown in FIG. 1. In this case, the two joint portions 2a and 2b are generally formed in two separate stages. For example, after the end portion 3a of the first dome 3 and one of the end portions 4a of the pipe 4 (on the left side in FIG. 2) are press-bonded to each other in a molten state, the end portion 5a of the second dome 5 and the other end portion 4b of the pipe 4 (on the right side in FIG. 2) are press-bonded to each other in a molten state. However, the method in which the two joint portions 2a and 2b are formed in two separate stages has a problem in that the time for manufacturing the liner 2 is difficult to reduce.

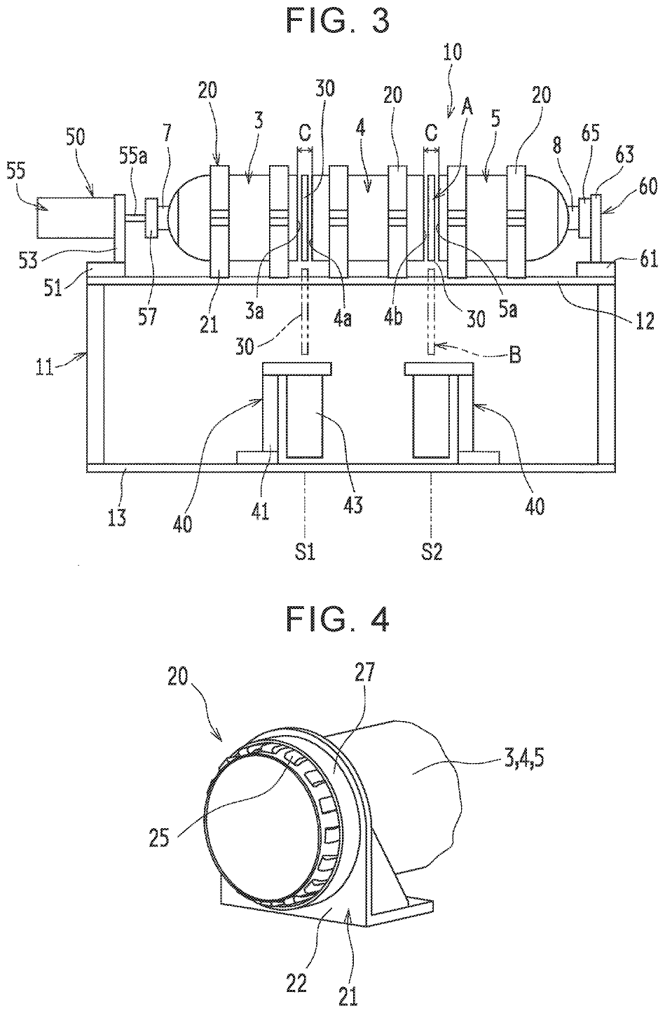

Thus, with an infrared welding device 10 according to the present embodiment (see FIG. 3), the end portions 3a, 4a, 4b, and 5a of the three liner component members 3, 4, and 5 are simultaneously melted through heating, are then moved relatively to one another while being held coaxially with one another, and are swiftly joined to one another.

FIG. 3 is a view schematically showing the infrared welding device 10. The infrared welding device 10 successively joins the three liner component members 3, 4, and 5 through welding, and is equipped with collet chucks 20, infrared radiation lamps 30, vertical operation mechanisms 40, a pressing mechanism 50, a pressure-receiving mechanism 60, and a base table 11 that supports these components.

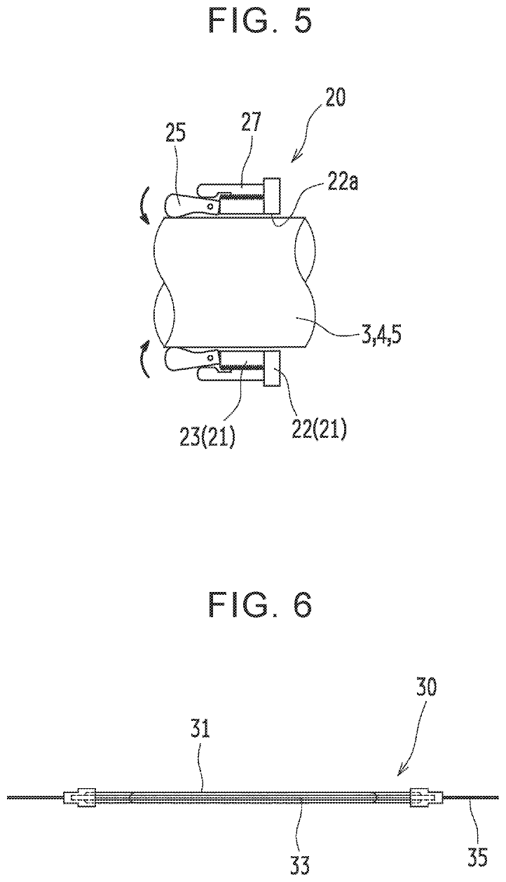

FIG. 4 is a perspective view schematically showing one of the collet chucks 20, and FIG. 5 is a cross-sectional view schematically showing one of the collet chucks 20. As shown in FIG. 3, two of the collet chucks 20 are provided for the first dome 3, another two of the collet chucks 20 are provided for the second dome 5, and the other two collet chucks 20 are provided for the pipe 4. That is, the six collet chucks 20 are provided. As shown in FIGS. 4 and 5, each of the collet chucks 20 has a holder portion 21, chuck portions 25, and a ring portion 27.

The holder portion 21 is fixed to an upper base frame 12 of the base table 11, and has a holder main body portion 22 through which a through-hole 22a through which the first dome 3, the pipe 4, or the second dome 5 is inserted is formed, and a cylinder portion 23 through which the first dome 3, the pipe 4, or the second dome 5 is inserted, as shown in FIG. 5. An external thread is formed on an outer peripheral surface of the cylinder portion 23. The holder portions 21 of the six collet chucks 20 are arranged on the upper base frame 12 such that centers of the through-holes 22a and axial centers of the cylinder portions 23 are aligned coaxially with one another.

The chuck portions 25 are provided at equal intervals in a circumferential direction of the cylinder portion 23. Each of the chuck portions 25 is turnably attached to a tip portion of the cylinder portion 23. The ring portion 27 is externally fitted to the cylinder portion 23. As shown in FIG. 5, an internal thread to which the external thread of the cylinder portion 23 is screwed is formed in an inner peripheral surface of the ring portion 27, as shown in FIG. 5. When the ring portion 27 is rotated, rotary motion thereof is converted into rectilinear motion thereof, so the ring portion 27 moves forward and backward in the axial direction of the cylinder portion 23. The ring portion 27 and the chuck portions 25 are configured such that the ring portion 27 moves toward a tip side of the cylinder portion 23 and the chuck portions 25 shrivel (decrease in diameter) as indicated by blackened arrows in FIG. 5, as the ring portion 27 is clamped (rotated in a predetermined direction).

With the collet chucks 20 configured as described above, when the ring portions 27 are clamped after the first and second domes 3 and 5 and the pipe 4 are inserted into the through-holes 22a and the cylinder portions 23 of the collet chucks 20 corresponding thereto respectively, the chuck portions 25 decrease in diameter, the first and second domes 3 and 5 and the pipe 4 are centered, and the first and second domes 3 and 5 and the pipe 4 are aligned coaxially with one another. Incidentally, the six collet chucks 20 are arranged on the upper base frame 12 such that a predetermined gap C is created between the end portion 3a of the first dome 3 and the end portion 4a of the pipe 4, and between the end portion 4b of the pipe 4 and the end portion 5a of the second dome 5, with the centering of the first and second domes 3 and 5 and the pipe 4 completed.

That is, the six collet chucks 20 are arranged on the upper base frame 12 such that the axial centers of the first and second domes 3 and 5 and the pipe 4 are aligned coaxially with one another, and that the predetermined gap C is created between the first dome 3 and the pipe 4 and between the pipe 4 and the second dome 5, with the centering of the first and second domes 3 and 5 and the pipe 4 completed. Therefore, in relation to the claims, each of the collet chucks 20 of the present embodiment is equivalent to “a member holding unit that holds a dome, a pipe, and another dome as the component members in this sequence, coaxially with one another and apart from one another” of the disclosure. Incidentally, in the present embodiment, the ring portions 27 are clamped to such an extent that the first and second domes 3 and 5 and the pipe 4 can slide in the axial direction while being centered.

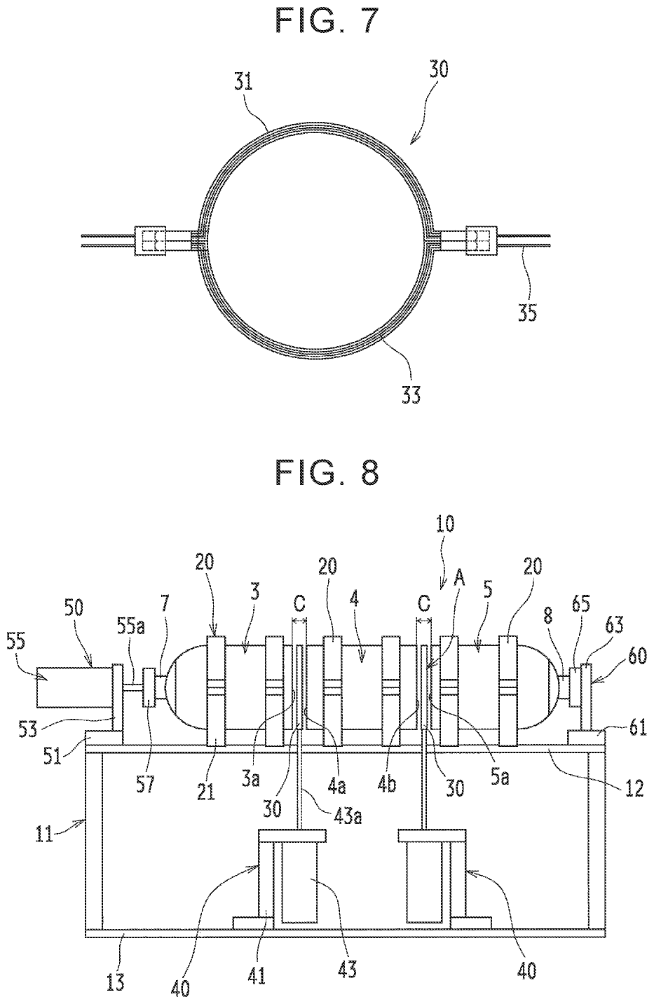

FIG. 6 is a plan view schematically showing one of the infrared radiation lamps 30, and FIG. 7 is a front view schematically showing one of the infrared radiation lamps 30. As shown in FIG. 3, the two infrared radiation lamps 30 are provided between the first dome 3 and the pipe 4 and between the pipe 4 and the second dome 5 respectively. As shown in FIGS. 6 and 7, each of the infrared radiation lamps 30 has a glass tube 31, a tungsten wire filament 33, and a conductive wire 35.

The glass tube 31 is constituted of a pair of semicircular portions forming a ring that is equal in diameter to the first and second domes 3 and 5 and the pipe 4. The tungsten wire filament 33 as well as inert gas is enclosed in the glass tube 31, and both end portions of the tungsten wire filament 33 are connected to an electric power supply (not shown) via the conductive wire 35.

Arranged between the end portion 3a of the first dome 3 and the end portion 4a of the pipe 4 that face each other across the gap C, and between the end portion 4b of the pipe 4 and the end portion 5a of the second dome 5 that face each other across the gap C, respectively, the infrared radiation lamps 30 thus configured radiate infrared light through energization of the tungsten wire filaments 33 respectively, and melt the end portion 3a of the first dome 3, the end portions 4a and 4b of the pipe 4, and the end portion 5a of the second dome 5 through heating respectively. Therefore, in relation to the claims, each of the infrared radiation lamps 30 of the present embodiment is equivalent to “a heating unit that is inserted between each of the domes and the pipe and that melts an end portion of each of the domes and an end portion of the pipe though heating by infrared light” of the disclosure.

As shown in FIG. 3, the two vertical operation mechanisms 40 are provided in such a manner as to correspond to the two infrared radiation lamps 30 respectively. Each of the vertical operation mechanisms 40 is equipped with a pedestal 41 that is fixed to the lower base frame 13 of the base table 11, and a piston 43 that is attached to the pedestal 41 and that has a piston rod 43a (see FIG. 8) capable of advancing and retreating in a vertical direction. Each of the infrared radiation lamps 30 is attached to a tip portion of the piston rod 43a.

When the piston rods 43a of the pistons 43 rise (advance), the vertical operation mechanisms 40 thus configured assume insertion positions (see Ain FIG. 3) where the annular infrared radiation lamps 30 are arranged between the end portion 3a of the first dome 3 and the end portion 4a of the pipe 4 and between the end portion 4b of the pipe 4 and the end portion 5a of the second dome 5 respectively concentrically therewith. On the other hand, when the piston rods 43a of the pistons 43 fall (retreat), the vertical operation mechanisms 40 thus configured assume retreat positions (see B in FIG. 3) where the annular infrared radiation lamps 30 have completely retreated from between the end portion 3a of the first dome 3 and the end portion 4a of the pipe 4 and between the end portion 4b of the pipe 4 and the end portion 5a of the second dome 5 respectively. Therefore, in relation to the claims, each of the vertical operation mechanisms 40 of the present embodiment is equivalent to “a moving unit that moves the heating unit between an insertion position where the heating unit is inserted between each of the domes and the pipe, and a retreat position where the heating unit is retreated from between each of the domes and the pipe” of the disclosure.

The pressing mechanism 50 is provided at an end portion of the upper base frame 12 of the base table 11 on the first dome 3 side. The pressing mechanism 50 is equipped with a base 51 that is fixed to the upper base frame 12, a stationary arm 53 that is attached to the base 51 and that extends upward, a piston 55 that is attached to the stationary arm 53 and that has a piston rod 55a capable of advancing and retreating in the axial direction, and a pressurization plate 57 that is attached to a tip portion of the piston rod 55a. The piston 55 is attached to the stationary arm 53 such that the pressurization plate 57 attached to the tip portion of the piston rod 55a is in contact with the ferrule 7 of the first dome 3 centered by the collet chucks 20, with the piston rod 55a advanced by a predetermined amount (in an initial state). A piston that can output a pressing force that is needed to press-bond the first dome 3 and the pipe 4 to each other is adopted as the piston 55.

In contrast, the pressure-receiving mechanism 60 is provided at an end portion of the upper base frame 12 of the base table 11 on the second dome 5 side. The pressure-receiving mechanism 60 is equipped with a base 61 that is fixed to the upper base frame 12, a stationary arm 63 that is attached to the base 61 and that extends upward, and a pressure-receiving plate 65 that is attached to the stationary arm 63. The pressure-receiving plate 65 is attached to the stationary arm 63 in such a manner as to be in contact with the ferrule 8 of the second dome 5 centered by the collet chucks 20.

Besides, although detailed description will be omitted, the base table 11 can be divided into three parts in the axial direction, at a division position S1 and a division position S2 in FIG. 3.

Incidentally, with the infrared welding device 10 according to the present embodiment, operations other than the insertion of the liner component members 3, 4, and 5 into the through-holes 22a and the cylinder portions 23 and the centering of the liner component members 3, 4, and 5 through the clamping of the ring portions 27 are controlled by a computer as a controller (not shown). In concrete terms, the heating by the infrared radiation lamps 30, the raising and lowering of the infrared radiation lamps 30 by the vertical operation mechanisms 40, the pressing by the pressing mechanism 50, and the like are performed based on commands from the controller, in accordance with programs that determine a heating time, operation timings, feed amounts of the piston rods 43a and 55a, and the like.

—Manufacturing Process—

Next, a manufacturing process through the use of the infrared welding device 10 configured as described above will be described. Each of FIGS. 8 to 10 is a view schematically illustrating the manufacturing process through the use of the infrared welding device 10.

First of all, the first dome 3 into which the ferrule 7 has been press-fitted, the pipe 4, and the second dome 5 into which the ferrule 8 has been press-fitted are prepared.

Then, the base table 11 is divided into three parts. The first dome 3 is inserted into the two collet chucks 20 provided on the part of the base table 11 located on the left side from the division position S1, the ring portions 27 are clamped to such an extent that the first dome 3 can slide, and the first dome 3 is thus centered. By the same token, the pipe 4 is inserted into the two collet chucks 20 provided on the part of the base table 11 located between the division position S1 and the division position S2, the ring portions 27 are clamped to such an extent that the pipe 4 can slide, and the pipe 4 is thus centered. By the same token, the second dome 5 is inserted into the two collet chucks 20 provided on the part of the base table 11 located on the right side from the division position S2, the ring portions 27 are clamped to such an extent that the second dome 5 can slide, and the second dome 5 is thus centered.

After that, when the three parts of the base table 11 obtained through division are combined with one another again, the first dome 3, the pipe 4, and the second dome 5 are aligned in this sequence coaxially with one another and apart from one another by the gap C. Incidentally, at this time, the infrared radiation lamps 30 are at the retreat positions respectively, the pressurization plate 57 of the pressing mechanism 50 is in contact with the ferrule 7 of the first dome 3 held by the collet chucks 20, and the pressure-receiving plate 65 of the pressure-receiving mechanism 60 is in contact with the ferrule 8 of the second dome 5 held by the collet chucks 20.

Then, the infrared radiation lamps 30 are moved from the retreat positions to the insertion positions by raising the piston rods 43a of the pistons 43 of the vertical operation mechanisms 40, respectively. As shown in FIG. 8, when the two infrared radiation lamps 30 are arranged between the end portion 3a of the first dome 3 and the end portion 4a of the pipe 4 and between the end portion 4b of the pipe 4 and the end portion 5a of the second dome 5, concentrically therewith, respectively, infrared light is radiated by simultaneously energizing the two infrared radiation lamps 30, and the end portion 3a of the first dome 3, both the end portions 4a and 4b of the pipe 4, and the end portion 5a of the second dome 5 are simultaneously melted through heating.

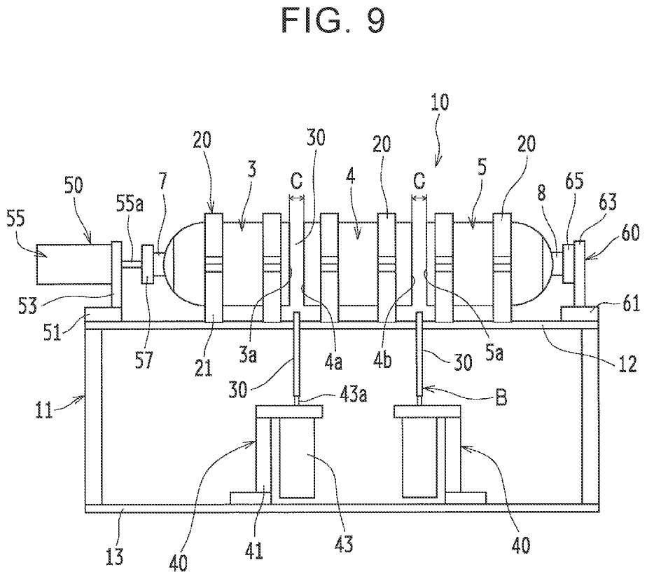

When the end portion 3a of the first dome 3, the end portions 4a and 4b of the pipe 4, and the end portion 5a of the second dome 5 are heated for a predetermined time by the infrared radiation lamps 30 respectively, the piston rods 43a of the pistons 43 of the vertical operation mechanisms 40 are lowered to simultaneously move the infrared radiation lamps 30 from the insertion positions to the retreat positions respectively, as shown in FIG. 9. In this manner, by retreating the infrared radiation lamps 30 to the retreat positions by the vertical operation mechanisms 40 after melting the end portion 3a of the first dome 3, the end portions 4a and 4b of the pipe 4, and the end portion 5a of the second dome 5 through heating through the use of the infrared radiation lamps 30, respectively, a state where the first dome 3, the pipe 4, and the second dome 5 can be joined to one another can be swiftly created.

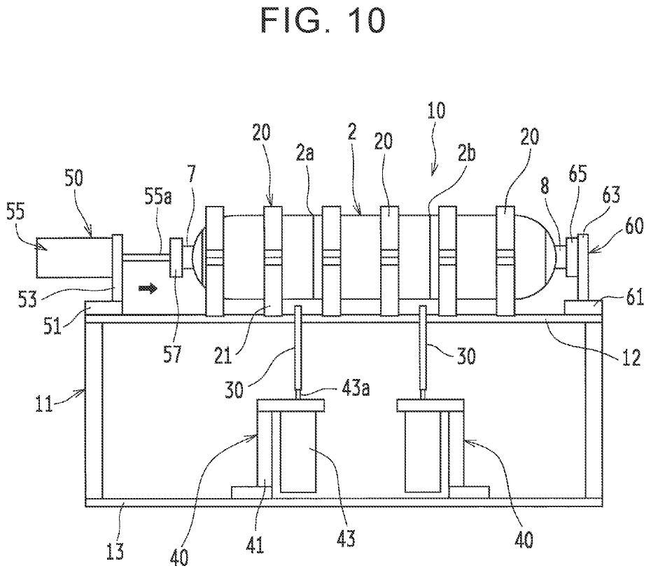

Subsequently, when the piston rod 55a of the pressing mechanism 50 is advanced in the direction indicated by a blackened arrow in FIG. 10, the pressurization plate 57 that is in contact with the ferrule 7 of the first dome 3 moves the first dome 3 toward the pipe 4, since the collet chucks 20 hold the first dome 3 slidably in the axial direction. When the piston rod 55a is advanced by a stroke that is as long as the gap C, the end portion 3a of the first dome 3 that has moved toward the pipe 4 is pressed against the end portion 4a of the pipe 4. When the piston rod 55a is further advanced, the first dome 3 and the pipe 4 move together toward the second dome 5 due to the pressing of the first dome 3, since the collet chucks 20 hold the pipe 4 slidably in the axial direction. When this movement is viewed from the second dome 5, the second dome 5 relatively moves toward the pipe 4.

When the piston rod 55a is advanced by a stroke that is twice as long as the gap C, the end portion 4b of the pipe 4 that has moved toward the second dome 5 together with the first dome 3 is pressed against the end portion 5a of the second dome 5, as shown in FIG. 10. When an attempt is made to further advance the piston rod 55a, the pipe 4 is about to press the second dome 5 in a pressing direction thereof, but the pressure-receiving mechanism 60 receives the second dome 5 to restrain the second dome 5 from moving in the pressing direction. Thus, the end portion 3a of the first dome 3 and the end portion 4a of the pipe 4 are firmly pressed against each other in the axial direction by a pressing force of the pressing mechanism 50, and the end portion 4b of the pipe 4 and the end portion 5a of the second dome 5 are firmly pressed against each other in the axial direction by a reactive force of the pressure-receiving mechanism 60. Accordingly, the first dome 3, the pipe 4, and the second dome 5 can be firmly press-bonded to one another. Thus, the good joint portions 2a and 2b can be obtained. Therefore, in relation to the claims, each of the pressing mechanism 50 and the pressure-receiving mechanism 60 is equivalent to “a pressing unit that relatively moves each of the domes toward the pipe and that presses the end portion of each of the domes against the end portion of the pipe” of the disclosure.

### Second Embodiment

The present embodiment is different from the foregoing first embodiment in that two pressing mechanisms are provided. The following description will focus on what is different from the first embodiment.

—Infrared Welding Device—

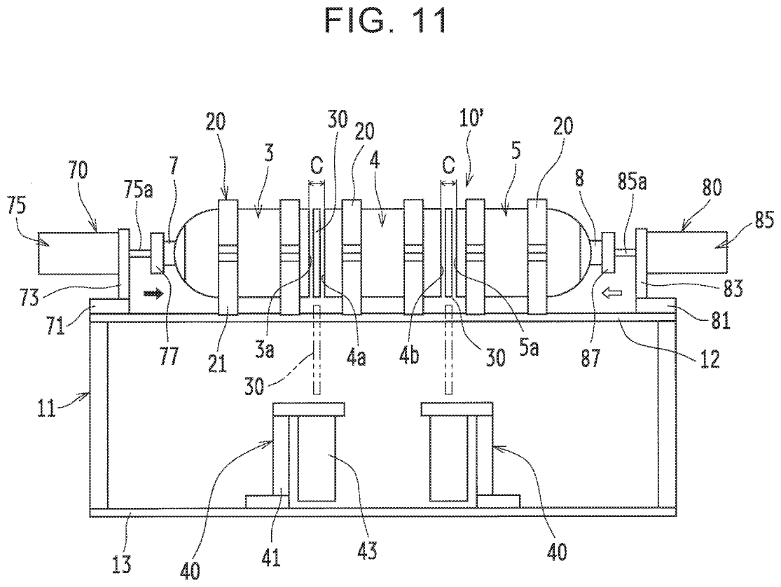

FIG. 11 is a view schematically showing an infrared welding device 10′ according to the present embodiment. As shown in FIG. 11, the infrared welding device 10′ is equipped with a first pressing mechanism 70 and a second pressing mechanism 80 as well as the base table 11, the six collet chucks 20, the two infrared radiation lamps 30, and the two vertical operation mechanisms 40.

The first pressing mechanism 70 is provided at the end portion of the upper base frame 12 of the base table 11 on the first dome 3 side. The first pressing mechanism 70 is equipped with a base 71 that is fixed to the upper base frame 12, a stationary arm 73 that is attached to the base 71 and that extends upward, a piston 75 that is attached to the stationary arm 73 and that has a piston rod 75a capable of advancing and retreating in the axial direction, and a pressurization plate 77 that is attached to a tip portion of the piston rod 75a. The piston 75 is arranged at such a position that the pressurization plate 77 is in contact with the ferrule 7 of the first dome 3 centered by the collet chucks 20, with the piston rod 75a advanced by a predetermined amount (in an initial state). As is the case with the piston 55, a piston that can output a pressing force that is needed to press-bond the first dome 3 and the pipe 4 to each other is adopted as the piston 75.

The second pressing mechanism 80 is provided at the end portion of the upper base frame 12 of the base table 11 on the second dome 5 side. The second pressing mechanism 80 is equipped with a base 81 that is fixed to the upper base frame 12, a stationary arm 83 that is attached to the base 81 and that extends upward, a piston 85 that is attached to the stationary arm 83 and that has a piston rod 85a capable of advancing and retreating in the opposite direction of the piston rod 75a, and a pressurization plate 87 that is attached to a tip portion of the piston rod 85a. The piston 85 is arranged at such a position that the pressurization plate 87 is in contact with the ferrule 8 of the second dome 5 centered by the collet chucks 20, with the piston rod 85a advanced by a predetermined amount (in an initial state). Incidentally, a piston that can output the same pressing force as the piston 75 of the first pressing mechanism 70 is adopted as the piston 85.

Incidentally, in the present embodiment as well, the ring portions 27 are clamped to such an extent that the first dome 3, the pipe 4, and the second dome 5 can slide in the axial direction.

—Manufacturing Process—

The first pressing mechanism 70 and the second pressing mechanism 80 are simultaneously operated after melting the end portion 3a of the first dome 3, the end portions 4a and 4b of the pipe 4, and the end portion 5a of the second dome 5 through heating through the use of the infrared radiation lamps 30 respectively, and retreating the infrared radiation lamps 30 to the retreat positions by the vertical operation mechanisms 40 respectively. When the piston rod 75a of the first pressing mechanism 70 is advanced in the direction indicated by a blackened arrow in FIG. 11, the pressurization plate 77 that is in contact with the ferrule 7 of the first dome 3 moves the first dome 3 toward the pipe 4, since the collet chucks 20 hold the first dome 3 slidably in the axial direction. By the same token, when the piston rod 85a of the second pressing mechanism 80 is advanced in the direction indicated by a blank arrow in FIG. 11, the pressurization plate 87 that is in contact with the ferrule 8 of the second dome 5 moves the second dome 5 in the direction opposite to the moving direction of the first dome 3, since the collet chucks 20 hold the second dome 5 slidably in the axial direction. When both the piston rod 75a and the piston rod 85a are advanced by a stroke that is as long as the gap C, the end portion 3a of the first dome 3 is pressed against the end portion 4a of the pipe 4, and at the same time, the end portion 5a of the second dome 5 is pressed against the end portion 4b of the pipe 4. In this manner, by using the two pressing mechanisms 70 and 80, the stroke can be made half as long as when the single pressing mechanism 50 is used. Therefore, the manufacturing time can be further reduced.

Incidentally, with the infrared welding device 10′ according to the present embodiment, even in the event of a deviation between a timing when the piston rod 75a is started and a timing when the piston rod 85a is started, when one of the piston rods is started before the other piston rod advances by a stroke that is twice as long as the gap C, the manufacturing time can be made much shorter than in the case where the single pressing mechanism 50 is used.

In addition, since the collet chucks 20 hold the first dome 3, the pipe 4, and the second dome 5 slidably in the axial direction respectively, the first dome 3, the pipe 4, and the second dome 5 can be firmly press-bonded to one another due to pressing forces of the first and second pressing mechanisms 70 and 80 that press the first and second domes 3 and 5 against the pipe 4 in opposite directions, as in the case where the pressure-receiving mechanism 60 is provided. Thus, the good joint portions 2a and 2b can be obtained.

### Third Embodiment

The present embodiment is different from the foregoing second embodiment in that the pipe 4 is immovably held in the axial direction. The following description will focus on what is different from the second embodiment.

—Infrared Welding Device—

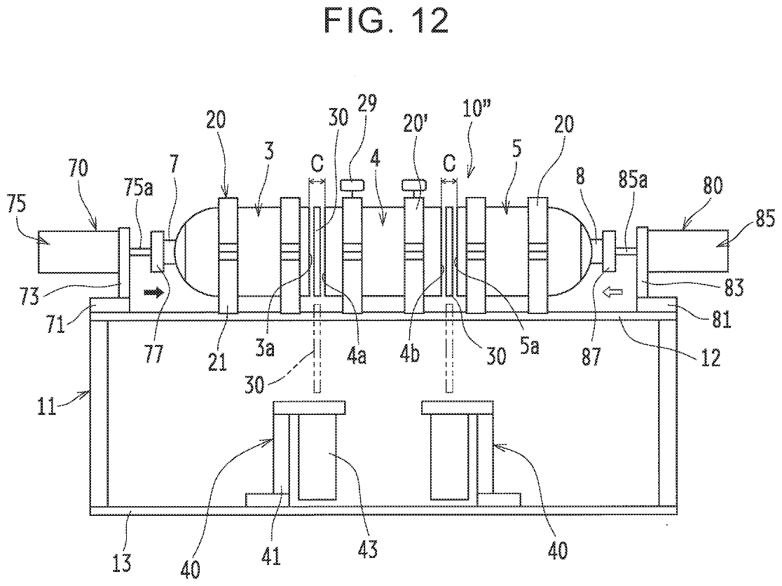

FIG. 12 is a view schematically showing an infrared welding device 10″ according to the present embodiment. As shown in FIG. 12, the infrared welding device 10″ is equipped with two collet chucks 20′ as well as the base table 11, the four collet chucks 20, the two infrared radiation lamps 30, the two vertical operation mechanisms 40, the first pressing mechanism 70, and the second pressing mechanism 80. Each of the collet chucks 20′ has a lock mechanism 29 that axially immovably holds the pipe 4. Incidentally, even when the lock mechanisms 29 as shown in FIG. 12 are not provided, the collet chucks 20′ that immovably hold the pipe 4 in the axial direction can also be realized by tightly clamping the ring portions 27 respectively. In the present embodiment, while the collet chucks 20 hold the first and second domes 3 and 5 slidably in the axial direction respectively, the collet chucks 20′ immovably hold the pipe 4 in the axial direction.

—Manufacturing Process—

The first and second pressing mechanisms 70 and 80 are simultaneously operated after melting the end portion 3a of the first dome 3, the end portions 4a and 4b of the pipe 4, and the end portion 5a of the second dome 5 through heating through the use of the infrared radiation lamps 30 respectively, and retreating the infrared radiation lamps 30 to the retreat positions by the vertical operation mechanisms 40 respectively. When the piston rod 75a of the first pressing mechanism 70 is advanced by a stroke that is as long as the gap C in the direction indicated by a blackened arrow in FIG. 12, and the piston rod 85a of the second pressing mechanism 80 is advanced by a stroke that is as long as the gap C in the direction indicated by a blank arrow in FIG. 12, the end portion 3a of the first dome 3 is pressed against the end portion 4a of the pipe 4, and at the same time, the end portion 5a of the second dome 5 is pressed against the end portion 4b of the pipe 4, since the collet chucks 20 hold the first and second domes 3 and 5 slidably in the axial direction respectively. In this manner, by using the two pressing mechanisms 70 and 80, the stroke can be made half as long as when the single pressing mechanism 50 is used. Therefore, the manufacturing time can be further reduced.

In addition, while the collet chucks 20 hold the first and second domes 3 and 5 slidably in the axial direction respectively, the collet chucks 20′ hold the pipe 4 immovably in the axial direction. Thus, even if there is a difference between the pressing force of the first pressing mechanism 70 and the pressing force of the second pressing mechanism 80, the first and second domes 3 and 5 and the pipe 4 can be firmly press-bonded to one another, without changing the position of the central pipe 4. Thus, the good joint portions 2a and 2b can be obtained.

### Other Embodiments

The disclosure is not limited to the embodiments, but can be carried out in various forms without departing from the spirit or main features thereof.

In each of the foregoing first and second embodiments, the two domes 3 and 5 and the pipe 4 are joined to one another, but the disclosure is not limited thereto. Two domes and two pipes may be joined to one another instead.

As described hitherto, the foregoing embodiments are nothing more than simple exemplifications, and should not be construed in a restrictive manner. Furthermore, all the modifications and alterations within a range that is equivalent to the claims fall within the scope of the disclosure.

According to the disclosure, the manufacturing time can be reduced while forming good joint portions even in the case where three or more liner component members are joined to one another. Therefore, the disclosure is highly advantageous in being applied to an infrared welding device that joins liner component members to one another through welding.

What is claimed is:

1. An infrared welding device that simultaneously or successively joins three component members constituting a liner of a tank to one another through welding, the infrared welding device comprising:
a member holding unit that holds a dome, a pipe, and another dome as the component members in this sequence, coaxially with one another and apart from one another;
a heating unit that is inserted between each of the domes and the pipe and that melts an end portion of each of the domes and an end portion of the pipe though heating by infrared light;
a moving unit that moves the heating unit between an insertion position where the heating unit is inserted between each of the domes and the pipe, and a retreat position where the heating unit is retreated from between each of the domes and the pipe; and
a pressing unit that relatively moves each of the domes toward the pipe and that presses the end portion of each of the domes against the end portion of the pipe, wherein
the member holding unit holds at least each of the domes slidably in an axial direction,
the moving unit retreats the heating unit to the retreat position, and the pressing unit presses the end portion of each of the domes against the end portion of the pipe, after the heating unit arranged at the insertion position melts the end portion of each of the domes and the end portion of the pipe through heating.

2. The infrared welding device according to claim 1, wherein
the member holding unit holds each of the domes and the pipe slidably in the axial direction, and
the pressing unit has a pressing mechanism that presses one of the domes against the pipe, and a pressure-receiving mechanism that receives the other dome and that restrains the other dome from moving in a direction in which that one of the domes is pressed by the pressing mechanism.

3. The infrared welding device according to claim 1, wherein
the member holding unit holds each of the domes and the pipe slidably in the axial direction, and
the pressing unit has a first pressing mechanism that presses one of the domes against the pipe, and a second pressing mechanism that presses the other dome in a direction opposite a direction in which that one of the domes is pressed by the first pressing mechanism, substantially simultaneously with pressing by the first pressing mechanism.

4. The infrared welding device according to claim 1, wherein
the member holding unit holds each of the domes slidably in the axial direction, and holds the pipe immovably in the axial direction, and
the pressing unit has a first pressing mechanism that presses one of the domes against the pipe, and a second pressing mechanism that presses the other dome in a direction opposite a direction in which that one of the domes is pressed by the first pressing mechanism, substantially simultaneously with pressing by the first pressing mechanism.

5. An infrared welding device that successively joins four component members constituting a liner of a tank to one another through welding, the infrared welding device comprising:
a member holding unit that holds a dome, two pipes, and another dome as the component members in this sequence coaxially with one another and apart from one another;
a heating unit that is inserted between each two of the component members and that melts end portions of each two of the component members through heating by infrared light;
a moving unit that moves the heating unit between an insertion position where the heating unit is inserted between each two of the component members, and a retreat position where the heating unit is retreated from between each two of the component members; and
a pressing unit that relatively moves each of the domes toward each of the pipes and that presses the end portion of each of the component members against the end portion of the component member adjacent to that one of the component members, wherein
the moving unit retreats the heating unit to the retreat position, and the pressing unit presses the end portion of each of the component members against the end portion of the component member adjacent to that one of the component members, after the heating unit arranged at the insertion position melts the end portions of each two of the component members through heating.
